(19) United States
(12) Patent Application Publication
(10) Pub. No.: US 2020/0250735 A1
(43) Pub. Date: Aug. 6, 2020

(54) PASSIVE MARKETING ON SOCIAL MEDIA

(71) Applicant: Michael Eaton Nabers, San Antonio, TX (US)

(72) Inventor: Michael Eaton Nabers, San Antonio, TX (US)

(21) Appl. No.: 16/779,613

(22) Filed: Feb. 2, 2020

Related U.S. Application Data
(60) Provisional application No. 62/801,207, filed on Feb. 5, 2019.

(51) Int. Cl. G06Q 30/06; G06Q 30/02; G06Q 50/00

(52) U.S. Cl. CPC G06Q 30/0631; G06Q 50/01; G06Q 30/0253

(57) ABSTRACT

A system for passive marketing comprising a social marketing server which presents a user interface for a social marketing site. The user interface offers options for selecting products for recommendation. Recommendation buttons for the recommended products are generated and displayed for other users linked to the activities and/or contents of the recommender on the social marketing site or on social media sites or on other third party sites which collaborate with the social marketing site. Product page corresponding to a recommendation button is loaded on being clicked by another user which provides options for buying and/or selling the recommended products.

### CROSS-REFERENCE TO RELATED APPLICATIONS

This application claims the benefit of U.S. Provisional Application No. 62801207, filed Feb. 5, 2019, the contents of which are incorporated herein by reference.

### FIELD OF THE INVENTION

The present invention relates to electronic advertising. More particularly, the present invention relates to presenting product or service recommendation on social media.

### BACKGROUND OF THE INVENTION

With the advent of internet, electronic commerce (E-commerce) or internet commerce has become extremely popular among the consumers. As an integral part of marketing, the merchants or marketers leverage Internet technologies to deliver promotional advertisements to consumers. But, the problem is, advertising on the electronic media is only getting more pervasive as online advertising has shifted dramatically toward much greater levels of intrusiveness in an effort to increase advertising effectiveness. As a result, online advertising has become increasingly annoying to users.

When a consumer considers buying, using or otherwise obtaining a particular product or service, the consumer tends to rely heavily on reviews available on that product or service. However, such reviews are often unreliable or untrustworthy as the product reviewers may have hidden motivations for recommending a particular product/service in order to influence the user's purchase. People at times have emotional reviews that are extreme as they have no reason to care about others' perception of them as a reviewer because there is no incentive for posting reviews. For instance, customers can leave an angry review right at the time they receive a product, if it's not exactly to their expectations, without taking the time to think about it. This can happen even if those expectations are self-created and not described in the product description. On the other hand, customers may get pressurized by sellers to give positive reviews. By providing incentives to reviewers for reviews with integrity, it may be argued that angry/emotional seldom thought-out reviews will be minimized.

Many online merchants take help from supporting tools such as product recommendation engines which are used to figure out the most suitable advices for consumers. These recommendation engines are believed to be more influential than the traditional recommendation sources such as “human experts” and “other consumers”. However, one of the problems associated with current recommendation services is that they typically generate recommendations based on the target user's aggregate activity or profile data, which typically spans a wide range of user interests, and recommendations based on such aggregate user activity frequently are not generally useful. Those recommendations are not generated by any person, but are recommended by software, and, are not as genuine or as real as a recommendation from a person.

It is obvious from the above discussion that multiple challenges exist in the field of product promotion/product recommendation. Present art also does not offer a platform to the ordinary users of Internet to promote or recommend a product to gain incentive without going through some tedious steps. Of course there is the concept of affiliate marketing in which people market third party products and services and the third party business rewards the affiliates for each visitor or customer brought by the affiliate's own marketing efforts. But, several disadvantages are associated with affiliate marketing or similar product promotion/recommendation methods. For example, affiliate marketing often involves providing an external site link instead of an open online marketplace platform, setting up an affiliate link requires time and investment and, often, affiliate marketing techniques are not integrated into a social media site etc. In fact, affiliate marketing still uses typical and traditional forms of advertising.

Accordingly, there exists a need in the art to overcome at least some of the deficiencies and limitations described herein.

### OBJECTS OF THE INVENTION

An object of the present invention is to provide a system for enabling passive product marketing on social media.

Another object of the present invention is to provide a method for enabling unobtrusive product recommendation.

Yet another object of the present invention is to provide a system for product recommendation compatible with social media platforms.

Still another object of the present invention is to provide a single platform for social media, product recommendation and e-commerce marketplace.

Another object of the present invention is to provide a method for displaying recommended products linked to the recommending user on social media platform.

Yet another object of the present invention is to provide a system that allows equal opportunity for everyone participating in product marketing to earn sales commissions or credits.

Still another object of the present invention is to provide a social media type platform that does not require spending money on typical/traditional advertising to exist or thrive.

### SUMMARY OF THE INVENTION

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The present invention is directed to a system and method for providing a platform for enabling a user to select one or more products/services for promotion which is/are then displayed linked to the profile/activities of the recommender on a social network or on other third party sites. The product recommendations are not pushed aggressively onto the social media sites. Rather, the product recommendations are displayed consistently and unobtrusively alongside the standard contents of the social media sites. As the product links are displayed associated with the recommending users, the campaign brings more credibility to the product promotion. If another user purchases a product following the product recommendation then the recommending user may get suitably rewarded. In one embodiment, the present system enables a single platform for recommending products, for displaying the recommendations linked to/associated with the recommender and for completing a transaction toward buying the recommended product by another user. In another embodiment, the present invention enables product selection on its own site and collaborates with third party sites such as social media sites, other online journal or informational website (e.g. blogs, vlogs etc.) and online streaming platforms/sites for posting the recommendations associated with the recommending user on those sites. Such collaboration can also be done with e-commerce sites. In this embodiment, the landing page to which a user is lead to upon clicking of a recommendation button can be hosted by a third party site. For this purpose, the present invention enables linking of the collaborating product/service websites with a social marketing site provided by the present invention and with the social media and other online journal or informational websites.

### BRIEF DESCRIPTION OF THE DRAWINGS

In order to describe the manner in which features and other aspects of the present disclosure can be obtained, a more particular description of certain subject matter will be rendered by reference to specific embodiments which are illustrated in the appended drawings. Understanding that these drawings depict only typical embodiments and are not therefore to be considered to be limiting in scope, nor drawn to scale for all embodiments, various embodiments will be described and explained with additional specificity and detail through the use of the accompanying drawings in which:

FIG. 1 shows a general architecture of a system for passive marketing on social media that operates in accordance with a first embodiment of the present invention;

FIG. 2 illustrates a flowchart depicting the general steps associated with passive marketing on social media method in accordance with an embodiment of the present invention;

FIG. 3 illustrates an exemplary screenshot showing a product selection page of the social marketing site in accordance with one embodiment of the present invention;

FIG. 4 illustrates an exemplary screenshot showing a user's social marketing site's social media account page in accordance with the first and second embodiments of the present invention;

FIG. 5 illustrates a screenshot showing an exemplary public page of a user's social media account page of the social marketing site that includes communications with one or more other users in accordance with the first and second embodiments of the present invention;

FIG. 6 illustrates an exemplary screenshot showing a product review page of the social marketing site in accordance with the first and second embodiments of the present invention;

FIG. 7 shows a general architecture of a system for passive marketing on social media that operates in accordance with the second embodiment of the present invention;

FIG. 8 illustrates a flowchart depicting the general steps associated with passive marketing on social media method in accordance with the second embodiment of the present invention; and

FIG. 9 illustrates an exemplary screenshot showing a product selection page of the social marketing site in accordance with the second embodiment of the present invention.

### DETAILED DESCRIPTION OF THE INVENTION

The following description is presented to enable any person skilled in the art to make and use the invention, and is provided in the context of particular applications of the invention and their requirements. Various modifications to the disclosed embodiments will be readily apparent to those skilled in the art and the general principles defined herein may be applied to other embodiments and applications without departing from the scope of the present invention. Thus, the present invention is not intended to be limited to the embodiments shown, but is to be accorded the widest scope consistent with the principles and features disclosed herein.

In the following detailed description, numerous specific details are set forth in order to provide a thorough understanding of the invention. However, it will be understood by those skilled in the art that the present invention may be practiced without these specific details. In other instances, well-known methods, procedures and components have not been described in detail so as not to obscure the present invention.

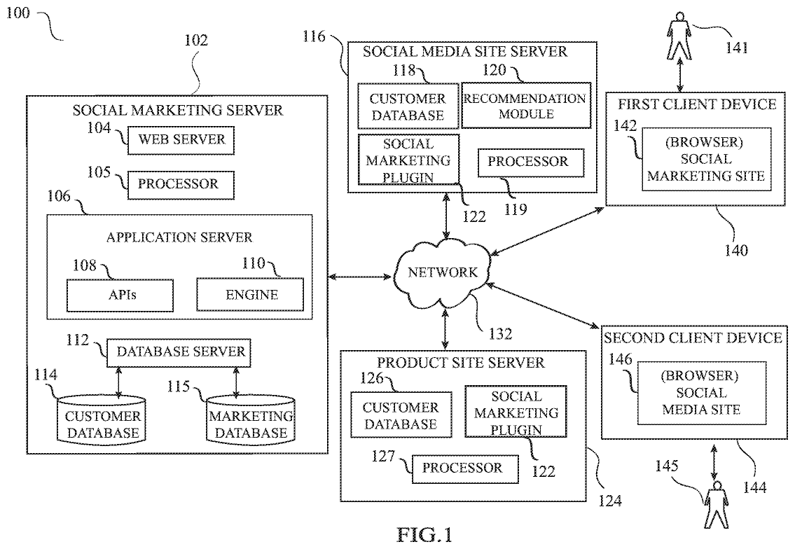

Reference to FIG. 1, the system 100 of the present invention, in accordance with its first embodiment, comprises a social marketing server 102, one or more third party website servers 116 (hereinafter referred to as social media server 116), one or more product site servers 124, one or more client devices (for example, first client device 140, second client device 144), all communicatively connected to each other through a network 132. In the present example, the social marketing server 102 facilitates selection of one or more products or services by a first user 141 on a social marketing site for posting recommendation buttons of those product(s) and/or service(s) linked/associated to one or more activities of the first user on selected third party sites (e.g. social media sites or social networking site or any other third party websites including personal web sites/pages etc. and online streaming sites) visible to other users of the third party sites. In some embodiments, the third party server 116 can be a media streaming server and the display of the recommendation buttons is done through media streaming services. For example, the recommendation buttons along with the recommenders can be displayed on a screen while streaming media contents through Internet such as through over-the-top (OTT) media service (e.g. during streaming of subscription based television programs or movies). The terms third party site, online streaming platforms and social media are used herein interchangeably and alternatively to refer applications and websites that enable users to create and share content with other users and, also for displaying of recommendation buttons with recommending users. The one or more user activities on the social networking website or social media may include user's interaction with one or more items of social media content, such as news stories, users' profiles, posts, communications with other users, comments or sub-comments etc. The recommendation buttons take a user of a social media/networking site to the respective product sites upon clicking of the buttons on which buying or selling of the products/services can be executed. The term “recommendation button” is used herein to refer to any form of online advertising of the product or service selected by a first user which is displayed linked/associated to the account of the first user on a first user selected third party site (e.g. social media site) at any suitable place on a webpage of the third party site wherever the information/profile/activities related to the first user 141 is accessed by other users (e.g. user 145) of the third party sites. The recommendation buttons can be interactive and can use text, still or moving graphics, or multimedia messages, and typically serve as hyperlinks such that the user is linked to website advertised in the button/banner when it is clicked on. The terms web page/web site, webpage or simply page or site are used herein to refer to a document that is suitable for the World Wide Web and web browsers. A web browser displays a web page on a monitor or mobile device.

The social marketing server 102 comprises a web server 104, an application server 106 and a database server 112. It will be appreciated that these servers may run on other machines that are accessible by the server machine 102. The application server 106 includes one or more application programming interfaces (APIs) 108 and at least an engine 110. The database server 112, that communicates to the application server 106, contains customer database 114 and marketing database 115 for storing customer information and marketing information respectively, Although, the databases are shown stored at the social marketing server 102, it will be appreciated that databases may be stored at other machines and database data may be uploaded to the social marketing server 102 when necessary.

Web server 104 offers web services to web clients, namely web browsers such as browser 142 installed on client device 140. Primarily, web server 104 retrieves web documents and sends them to a web browser. The one or more APIs 108 serve as the external layer that connect to the first site (e.g. social media/networking site) and second site (e.g. product site) via the respective social marketing plugin components 122, when a relevant request is required depending on a specific client interaction. In general, an API is a particular set of rules and specifications that a software program may follow to access and make use of the services and resources provided by another particular software program that implements that API. The API serves as an interface between different software programs and facilitates their interaction.

The engine component 110 routes requests according to the source site (e.g. first site) based on the specific marketing of a product (the term “product” is being used hereinafter to refer both product and services) as recorded in the marketing database 115 through database server 112. The customer database 114 contains the personal data of users who have registered with the social marketing server 102. The marketing database 115 contains information regarding products and services and, preferably, unique identifiers provided with the recommendation/advertising buttons/banners/links which relates the recommending user, site on which the recommendation is displayed and the product site.

The components appearing in the Social marketing server 102 refer to an exemplary combination of those components that would need to be assembled to create the infrastructure in order to provide the tools and services contemplated by the present invention. As will be apparent to one skilled in the relevant art(s), all of components “inside” of the Social marketing server 102 may be connected and may communicate via a wide or local area network (WAN or LAN).

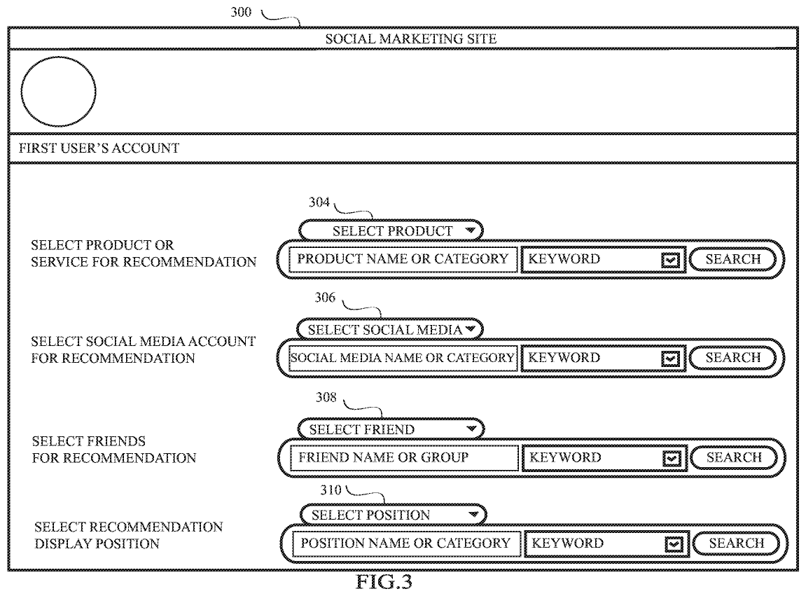

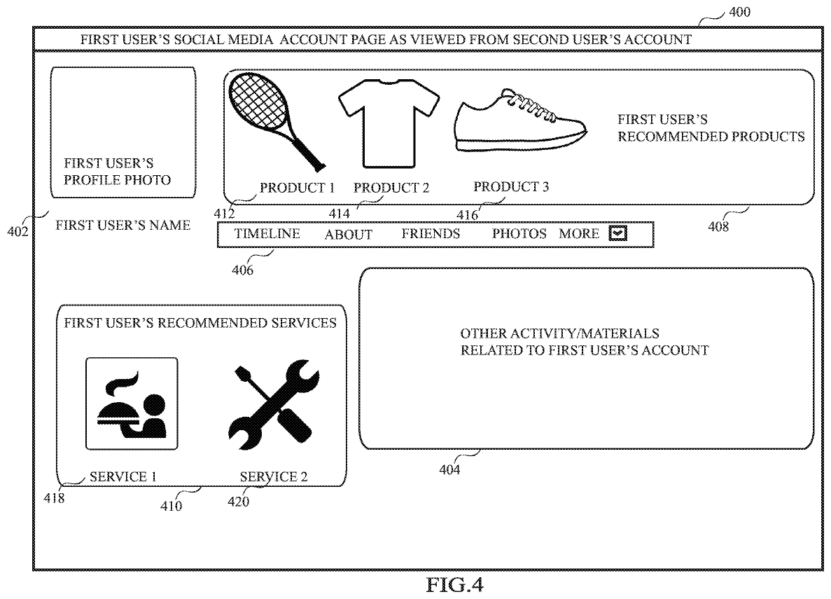

Reference to FIG. 1 and FIG. 3, the social marketing server 102 provides a website, first website 300 (also referred to as social marketing site 300 alternatively and interchangeably), for example, on the client device 140 through the browser 142. The social media site server 116 includes a customer database 118, a recommendation module 120 and a social marketing plugin 122. The customer database 118 contains personal data of users. The recommendation module 120 provides the recommendation button (such as advertising links or banners or buttons 412, 414, 416, 418, 410 etc. as shown in FIG. 4) on the client device's browser.

The product site's server 124 comprises a customer database 126 and plugin 122. The product site server 124 presents the product page i.e. the landing page to which the browser is redirected after the user 145 clicks on any recommendation button on the social media/networking site 146. The landing page i.e. the product page may include details of the product and it allows the user to buy or sell the product/service. The product page can be a webpage of any online e-commerce site.

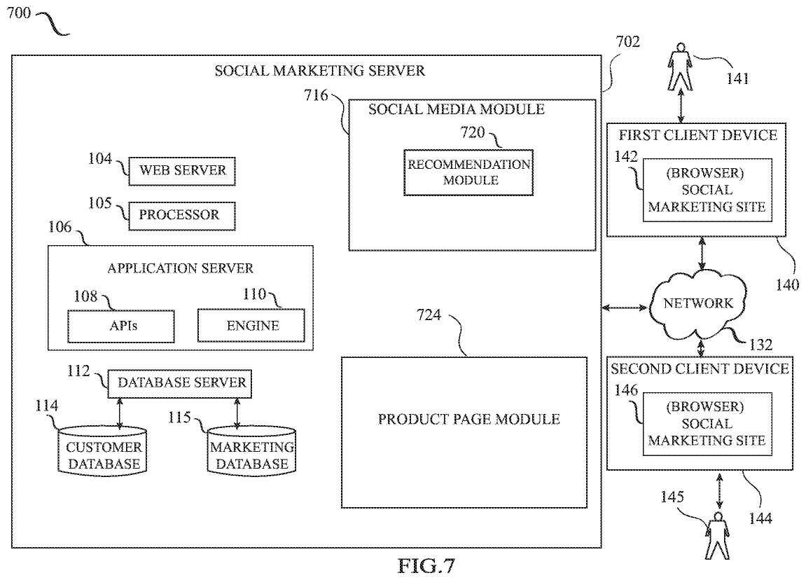

The client devices 140 and 144 of FIG. 1 or of FIG. 7 may be any device capable of presenting data and having an input device. The client devices 140 and 144 may include, but not limited to, personal computers, server computers, mobile devices, tablets, hand-held or laptop devices, smart phones, personal digital assistants or any similar devices. Browser 142 or 146 is a graphical browser application that allows a user to view Internet or intranet content. Using the browser, the user may interact with, for example, the social marketing site, social media site and the product site to recommend and buy/sell products.

The social marketing server 102, the social media server 116 and the product site server 124 may include a physical processor (processor 105, 119 or 127 as shown in FIG. 1). The social marketing server and the social media server perform a portion or all of the processing steps of product recommendation method described herein in response to the processors executing one or more sequences of one or more instructions contained in a memory included in the servers. Such instructions may be read into the memory from another computer readable medium, such as a hard disk or a removable media drive. One or more processors in a multi-processing arrangement may also be employed to execute the sequences of instructions contained in memory. The term “computer readable medium” as used herein refers to any medium that participates in providing instructions to the processors for execution. A computer readable medium may take many forms, including but not limited to, non-volatile media, volatile media, and transmission media. Non-volatile media includes, for example, optical, magnetic disks, and magneto-optical disks, such as the hard disk or the removable media drive.

As used herein, the term “network” generally refers to any collection of distinct networks working together to appear as a single network to a user. The term also refers to the so-called world wide “network of networks” i.e. Internet which is connected to each other using the Internet protocol (IP) and other similar protocols. As described herein, the exemplary public network 132 of FIG. 1 or of FIG. 7 is for descriptive purposes only and it may be wired or wireless. Although the description may refer to terms commonly used in describing particular public networks such as the Internet, the description and concepts equally apply to other public and private computer networks, including systems having architectures dissimilar to that shown in FIG. 1 or in FIG. 7.

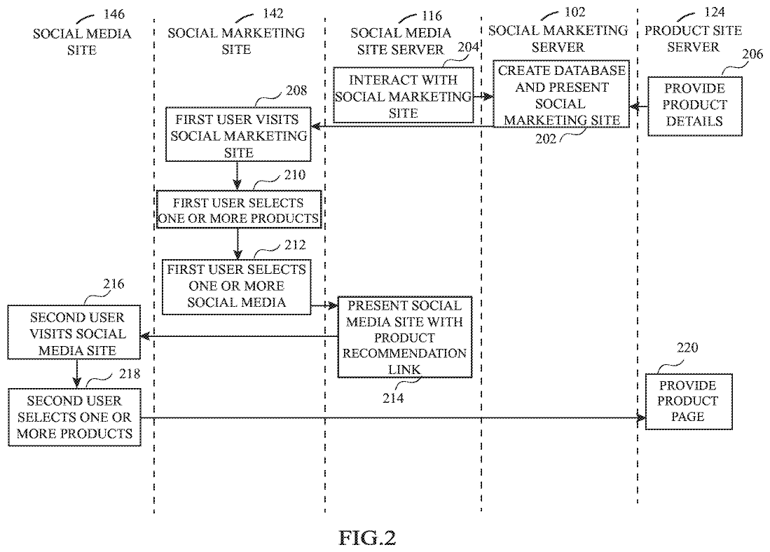

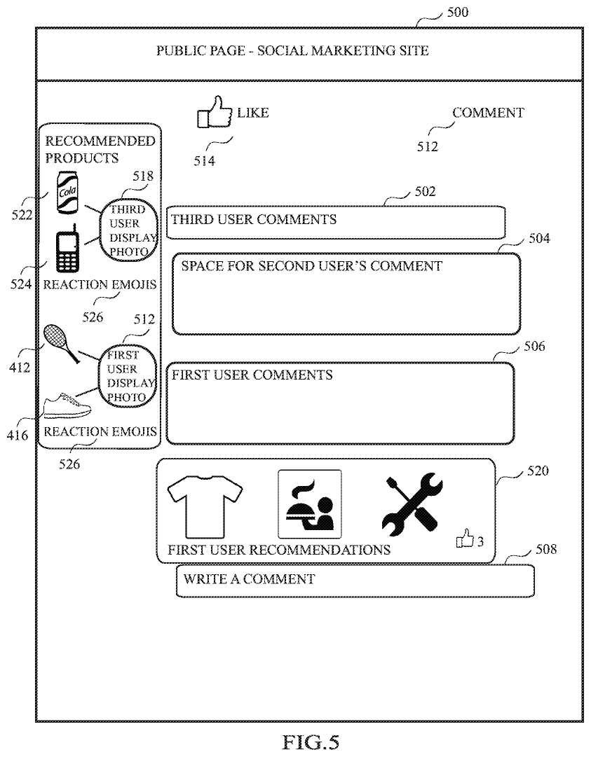

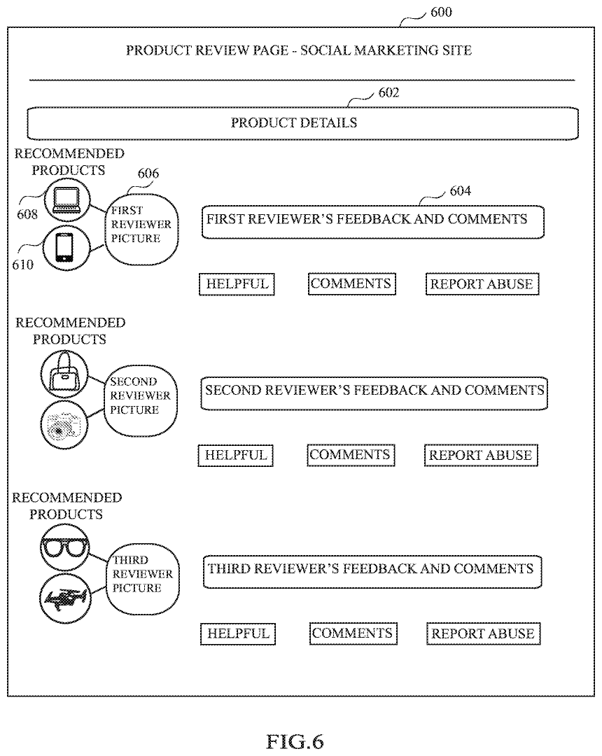

In the context of the present example, the steps of the present invention are described with reference to FIG. 1, FIG. 2, FIG. 3, FIG. 4, FIG. 5 and FIG. 6 below.

The present invention enables an ordinary user of social media or any other website to market products and services without being intrusive or aggressive. The social marketing server 102 presents the social marketing site which lets a user get registered with the site, select one or more products and services for recommendation which, in turn, can provide incentive to the recommender if another user buys that product or service based on that recommendation. The social marketing server 102 collaborates with social media sites and the product sites to execute the steps involved in the process in accordance with the first embodiment of the invention. As in step 204 of FIG. 2, the social marketing server 102 interacts with the social media site server 116, as in step 204 of FIG. 2, to exchange the required details. Similarly, the social marketing server 102 also interacts with the product site server 124, as in step 206, to exchange the required details. These details are used by the social marketing server 102, as in step 202, to create a unique code against each product/service that a vendor or user wants to promote, each user of the social marketing site who is recommending the product/service and, also, against each user of the social media who buys that product/service based on that recommendation.

FIG. 3 illustrates an exemplary page 300 of the social marketing site 142. First user 141 may get registered with the social marketing site by providing the required details following a standard registration process. Once logged into the social marketing site, as in step 208 of FIG. 2, the registered first user 141 will get to select one or more products or services, as in step 210, which the first user himself/herself wants to sell or which the first user wants to promote on behalf of third party vendors or which is sold by the social marketing site company itself. In some embodiments, for the third party sites with whom the social marketing server 102 collaborates, the first user is allowed to login to the third party sites using the first user's social marketing site's account credential. In such cases, the options for selecting the one or more products or services can be displayed on the third party sites also. As shown in FIG. 3, the social marketing site may provide options 304 for selection of one or more products by product/service name, category etc. for recommendation on the social marketing site or on the third party sites. The first user 141 will then may have to select, as in step 212 of FIG. 2, one or more accounts held by the first user on one or more social media sites if the first user is accessing the social marketing site. This step is not required if a user logs in to a collaborating third party social media or other site using the user's social marketing site's account credential. The social marketing site may provide options 306 for selection of the social media account to which the selected product/service will be linked to and/or from which social media profiles of users can be imported. In one preferred embodiment, optionally, the social marketing site lets a user invite one or more other users from the collaborating social media sites to the social marketing site from the options 308 as shown in FIG. 3 and the product recommendations are made visible to those users who accept the invitation. In a situation where certain friends or followers are not selected to see specific products selected for them, there will be default products selected by the user to be displayed to them, which are consistent to the ones displayed to everyone else, who are not friends/fans/followers. Further, the social marketing site may also let the first user select the position/area on the page of the social media account at which the selected products/services should be displayed from options 310.

Once the selections are made by the first user, the selected social media site, as in step 214 of FIG. 2, will present the selected/recommended products/services as recommendation buttons linked to the profile/activities/communications related to the first user. In another embodiment, whenever a user accesses his/her account on any third party site (including sites owned by the user), which is being synchronized with the social marketing site (e.g. by accessing the third party site with the user's social marketing site's credential), the recommendation buttons are displayed together with the contents/activities of the user on the pages of the third party site related to the user. As shown in FIG. 4, a webpage 400 of the social media account of the first user, as viewed by a second user 145 on his/her social media account, displays the various recommendations buttons for the products/services selected by the first user along with the other usual content of the social media site. For example, webpage 400 can be the profile page/home page of the social media account of the first user seen by the second user from the account of the second user on the social media account. On this exemplary webpage, the products 412, 414 and 416 and the services 418 and 420 recommended by the first user are displayed as recommendation buttons associated with/linked to/alongside the usual contents of social media such as first user's name and profile photo/cover photo/display picture 402, other activity description of the first user 404 and the timeline, friends etc. buttons 406. The recommendation buttons can be placed at any suitable place/position on a webpage of social media for display. Accordingly, the recommendation buttons can be placed inside panels as shown in 408 or 410 of FIG. 4 or can be placed distributed over the screen.

FIG. 5 illustrates an exemplary public page 500 from a user's social media account. In this example, the second user is accessing, as in step 216 of FIG. 2, the social media site which the first user has selected for displaying the product recommendation buttons. The recommendation buttons may appear at any place on the webpage as selected by the first user and/or as allowed by the second user. Preferably, the recommendation buttons are presented on the social media webpage linked to/associated/together with the content related to the recommender on the recommender's personal profile, from a Page that is setup, from a Group, from a Newsfeed, or anywhere else where exposure and engagement occurs. It is to be noted that a user may be allowed to select many products for recommendation and, thus, the products presented as recommendation buttons can be any product selected by a user for recommendation, even if those are not the same products displayed by the user on the personal profile page. In a preferred embodiment, it can be set that, irrespective of the total number of products recommended by a first user, the other users get to see only those recommended products which match the other users' interest in terms of search terms, purchase history, groups and pages that they have joined or interacted with, or words that they have typed on the platform etc. In FIG. 5, the recommendation buttons (recommendation buttons 522, 524, for example) are shown linked to user icon of the recommender (to user icon 518, for example). In another example, products 412 and 416 selected by the first user 141 for recommendation are displayed linked to the user icon (display photo/image/video, for example) 512 or any other content/activities related to the first user on the webpage 500 which can identify/represent the recommending user on the social marketing site in all interactions across the platform. Similarly, for other users (third user, for example) with whom the second user has interaction with, on the social media platform, the recommendation buttons 522 and 524 for the products/items selected by the recommending user are shown linked to the respective user icon (e.g. linked to the display photo 518 of third user). In another embodiment, a number of recommendation buttons with or without their corresponding recommenders or a number of recommenders with or without their recommendations can be displayed clubbed together at any place/section/panel on a web page.

As shown in FIG. 5, the feedback/reaction given by one or more users against a recommended product can be shown in terms of reaction emojis 526 or through other similar means such as feedback stars etc. In some embodiments, the recommendation buttons for the recommended products/services of a particular user can be shown associated with any identifying interaction/communication of the recommending user on the webpage of the social media site. For example, the recommendation buttons 520 are displayed as recommendations of the first user and, also, a feedback box 508 is provided for giving feedback on the recommended products by other users. All these features of the social marketing site are displayed on the social media site alongside the usual features/contents of the social media site (e.g. communications/chats 502, 504, 506 and likes 514, comments 512 or any sub-comments etc.).

In the product review page of the present invention the recommendation buttons corresponding to products/services recommended by the reviewer are displayed linked/next to or close to the review and reviewer's icon or activity/content. Reference to FIG. 6, as shown in product review page 600, products/services recommended by a particular user (for example, by first reviewer) who posts reviews/gives feedback (feedback 604, for example) against a product (product 602, for example) are also shown linked (for example, recommendation buttons 608 and 610) to a user icon of the reviewer (for example, icon 606 of the first reviewer). This will increase the number of reviews, the detail of the reviews, and the authenticity of the reviews, as reviewers could potentially be rewarded if another user who is reading product reviews clicks on a reviewer's recommendations and then purchases the recommended product.

If the second user clicks on any recommendation button linked to the first user, as in step 218 of FIG. 2, the browser directs the second user to the site on which the product is listed. If the marketing campaign for the particular product becomes successful (e.g. the second user buys the product from the landing page) the first user may get rewarded/ given an incentive, monetary or otherwise.

Reference to FIG. 7, in the second embodiment, the social marketing system 700 of the present invention comprises a social marketing server 702 and one or more client devices (for example, first client device 140, second client device 144), all communicatively connected to each other through a network 132. In this embodiment, the social marketing system provides a single website for selection and recommendation of products/services, for promotion of the recommended products/services on a social media page/site of the same social marketing site and for buying/selling a recommended product on an ecommerce page/site of the same social marketing site which is loaded upon clicking of the recommendation buttons. A user of the social marketing site of this embodiment needs to create just a single account to access the features such as product recommendation, posting/displaying of the recommended products (recommendation buttons) on social media and for doing transaction on ecommerce page, all on the same website, unlike the system described above with respect to FIG. 1 in which the social marketing site, the social media sites and the product sites are hosted on separate platforms. In the present embodiment, the term social media site/page is used to refer website/webpage/page provided by the social marketing server 702 that enables users to create and share content with each other. The recommendation buttons take a user of the social media page presented by the social marketing server to the respective product pages of the social marketing site upon clicking of the buttons on which buying or selling of the products/services can be executed. The term “recommendation button” is used herein to refer to any form of online advertising of the product or service selected by a user which is displayed linked/associated to/with the activities/content related to this recommending user on the social media page/site at any suitable place on the social media pages wherever the information/profile/activities related to the recommending user is displayed.

The social marketing server 702 comprises a web server 104, an application server 106 and a database server 112. The application server 106 includes one or more application programming interfaces (APIs) 108 and at least an engine 110. The database server 112 that communicates to the application server 106 contains customer database 114 and marketing database 115 for storing customer information and marketing information respectively. The social marketing server 702 further comprises a social marketing module 716 and a product page module 724.

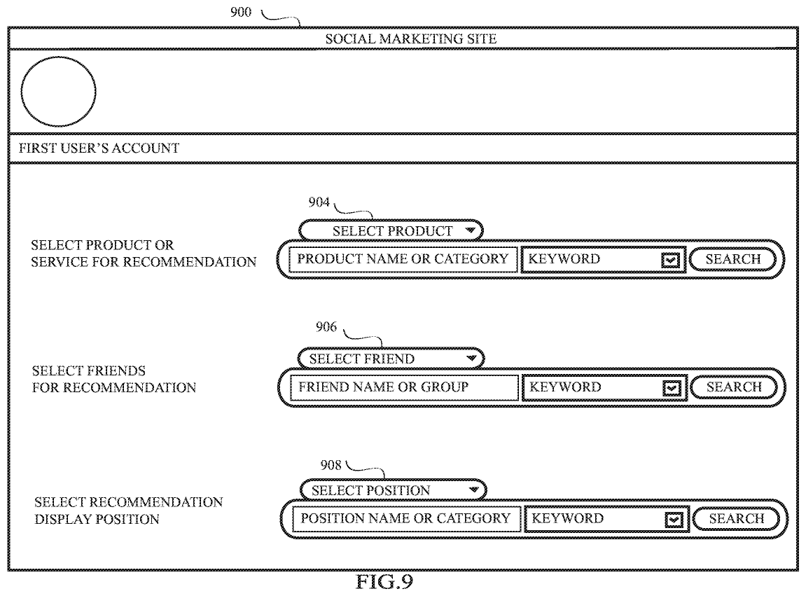

Reference to FIG. 7 and FIG. 9, the social marketing server 702 provides the social marketing website 900, for example, on the client device 140 through the browser 142. The social media module 716 includes a recommendation module 720 which provides the recommendation buttons (such as advertising links or banners or buttons 412, 414, 416, 418, 410 etc. as shown in FIG. 4) on the social marketing site.

The product module 724 presents the product page i.e. the landing page of the social marketing site to which the browser is redirected after the user 141 or 145 clicks on any recommendation button on the social media page of the social marketing site. The landing page i.e. the product page may include details of the product and reviews and it allows the user to buy or sell the product/service.

The social marketing server 702 includes a physical processor 105 which performs a portion or all of the processing steps involved in product recommendation, recommendation presentation and buying/selling of recommended product described herein in response to the processors executing one or more sequences of one or more instructions contained in a memory included in the servers. Such instructions may be read into the memory from another computer readable medium, such as a hard disk or a removable media drive. One or more processors in a multi-processing arrangement may also be employed to execute the sequences of instructions contained in memory. The term “computer readable medium” as used herein refers to any medium that participates in providing instructions to the processors for execution. A computer readable medium may take many forms, including but not limited to, non-volatile media, volatile media, and transmission media. Non-volatile media includes, for example, optical, magnetic disks, and magneto-optical disks, such as the hard disk or the removable media drive.

In the context of the second embodiment, the steps of the present invention are described with reference to FIGS. 4 to 9 below. All the steps involved in this embodiment of the present invention are almost the same as those described with respect to the first embodiment (FIGS. 1 to 3) except that the product selection/recommendation page, social media page and the product page are all extensions of the same social marketing site.

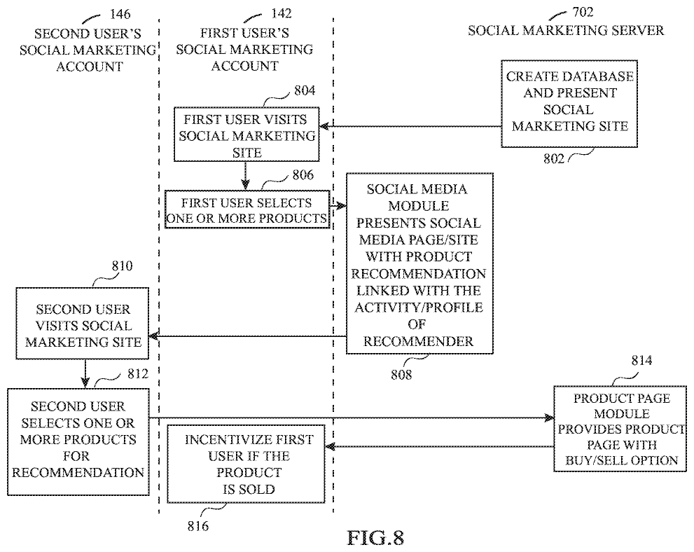

Similar to the first embodiment described above with respect to FIG. 1 and FIG. 2, this second embodiment of the present invention also enables an ordinary user to market products and services on social media/third party sites/online streaming platforms without being intrusive or aggressive. Reference to FIG. 7 and FIG. 8, the social marketing server 702 presents, as in step 802, a social marketing site which allows product recommendation, display of recommended product linked to/associated with/next to/together with the recommender for all/some interactions/activities of the recommender with other users of the social marketing site (e.g. next to the icon of the recommender or next to the comments of the recommender) and buying/selling of recommended products.

FIG. 9 illustrates an exemplary page 900 of the social marketing site. First user 141 may get registered with the social marketing site by providing the required details following a standard registration process. Once logged into the social marketing site, as in step 804, the registered first user 141 will get to select one or more products or services, as in step 806, which the first user himself/herself wants to sell or which the first user wants to promote on behalf of third party vendors or which the first user wants to promote a product that is sold by the social marketing site company itself. As shown in FIG. 9, the social marketing site may provide options 904 for selection of one or more products by product/service name, category etc. for recommendation. Optionally, the social marketing site may also allow selection of one or more friends to which the first user wants to display the recommended products/services from the options 906 as shown in FIG. 9. Further, the social marketing site may also let the first user select the position/area on the page of the social media account at which the selected products/services should be displayed from options 908.

The social media page of the present invention comprises all the usual content/features which other social media sites have. In addition, the social media module 716 of the social marketing server 702, as in step 808 of FIG. 8, presents the user selected products/services as recommendation buttons linked/associated and/or next to the profile/activities/communications related to the recommending user on the social marketing site. As in the first embodiment, this second embodiment of the present invention will also present exemplary webpages similar to those shown in FIG. 4, FIG. 5 and FIG. 6. But, in the second embodiment, the social media pages and product pages are all integral parts of the same social marketing site and the users essentially carry out all the activities related to product recommendation, social networking and product buying/selling on the same platform. Thus, when a second user visits the social marketing site, as in step 810, the second user gets to see the recommendation buttons linked/associated and/or placed next to the corresponding users on the social marketing site who recommended the products/services. If the second user clicks on a recommendation button (such as recommendation buttons 412, 416, 522 and 524, for example), as in step 812, the corresponding product page is presented on the browser as in step 814 by the product page module 724. If the user buys the product/service then the user may get incentivized, as in step 816.

In some embodiments, the social marketing site offers premium account to users. These premium accounts can be granted to users who are willing to pay a fee for the premium account, or if they reach certain milestones such as sales, views, clicks, number of reactions (emojis, likes, thumbs up, etc), comments, or other. With the premium account, users are able to select many more products or services. Because, they are selecting them as a product they recommend, it is still a genuine recommendation. For the second user viewing, the limited products that will be displayed to them will only be the ones most related to the second user's search term history, previous purchases, or interests (e.g. based on the pages the second user might have visited or interacted with or groups and categories the second user joined). In other words, the product recommendations displayed to a particular user can be those based on the user's interest.

The advantages of putting the recommendation buttons linked to/associated with/next to the activities of the recommender or to the icon of the recommender are—(1) the product recommendations appear more authentic as the recommender is known to the second user, (2) the product recommendations are unintrusive as the recommendation buttons are displayed alongside the normal contents of the social media site and the promotions are consistent in placement and of consistent size, shape, and format, and users will be expected to see them from their own exposure as well as from others' (when product placements are in a consistent placement, it does not bother or disrupt the users' expectations. It is comparable to viewing a commercial during the Time-out of a sports event. People expect to see them and even enjoy the commercials), (3) any ordinary user can become an entrepreneur as the product recommendations may incentivize the recommending user. The present invention makes promotion of product very easy. As one is setting up a Social Media profile and account, there is an extra step wherein they search and select a specified number of products available for them to select from, which will be automatically recommended by them during interactions on the social media platform.

Flowcharts are used to describe the steps of the present invention. While the various steps in these flowcharts are presented and described sequentially, some or all of the steps may be executed in different orders, may be combined or omitted, and some or all of the steps may be executed in parallel. Further, in one or more of the embodiments of the invention, one or more of the steps described above may be omitted, repeated, and/or performed in a different order. In addition, additional steps, omitted in the flowcharts may be included in performing this method. Accordingly, the specific arrangement of steps shown in FIG. 2 and in FIG. 8 should not be construed as limiting the scope of the invention.

What is claimed is:

1. A computer-implemented method for passive marketing, said method being implemented in a social marketing server having one or more physical processors programmed with computer program instructions that, when executed by said one or more physical processors, cause said social marketing server to perform said method, said method comprising:
providing, by said social marketing server, a user interface for a social marketing site on a client device, said user interface comprising one or more options for selecting one or more products for recommendation;
linking, by said social marketing server, one or more recommended products selected by a first user to an account of said first user on said social marketing site from said one or more options for selecting said one or more products for recommendation;
displaying, by said social marketing server, one or more recommendation buttons representing said one or more recommended products on one or more web pages related to said account of said first user on said social marketing site; and
loading, by said social marketing server, a product page on said client device upon clicking of a recommendation button from said one or more recommendation buttons, said product page having one or more options for buying and/or selling said one or more recommended products.

2. The method of claim 1, wherein said display of said one or more recommendation buttons on said one or more web pages is made together with one or more activities and/or contents related to said first user.

3. The method of claim 1, wherein said display of said one or more recommendation buttons on said one or more web pages are viewable from an account of one or more other users of said social marketing site.

4. The method of claim 3, wherein said display of said one or more recommendation buttons are viewable to said account of said one or more other users as per interest of said one or more other users.

5. The method of claim 3, wherein said user interface further comprises one or more options for selecting said one or more other users.

6. The method of claim 1, wherein said user interface further comprises one or more options for selecting a position on said one or more web pages for said display of said one or more recommendation buttons.

7. The method of claim 1, wherein said one or more recommendation buttons are interactive.

8. The method of claim 3, wherein said social marketing server enables incentivizing said first user of said social marketing server upon buying and/or selling of said one or more recommended products by said one or more other users.

9. The method of claim 1, wherein said product page is loaded from a third party site.

10. A system for passive marketing, said system comprising:
a social marketing server comprising one or more physical processors programmed with computer program instructions that, when executed by said one or more physical processors, program said social marketing server to:
interact with one or more third party sites to present one or more options for selecting one or more products for recommendation, said one or more options being presented on said one or more third party sites or on a social marketing site provided by said social networking server;
link one or more recommended products selected by a first user to an account of said first user on said one or more third party sites or on said social marketing site, said one or more recommended products being selected by said first user from said one or more options;
display one or more recommendation buttons representing said one or more recommended products on one or more web pages related to said account of said first user on said one or more third party site or on said social marketing site, said one or more recommendation buttons being displayed together with one or more activities and/or contents related to said first user; and
load a product page having one or more options for buying and/or selling said one or more recommended products upon clicking of a recommendation button from said one or more recommendation buttons by one or more other users.

11. The system of claim 10, wherein said display of said one or more recommendation buttons are viewable to said one or more other users as per interest of said one or more other users.

12. The system of claim 10, wherein said user interface further comprises one or more options for selecting a position on one or more web pages of said social networking site or on said one or more third party sites for said display of said one or more recommendation buttons.

13. The system of claim 10, wherein said product page is loaded from a third party site.

14. The system of claim 10, wherein said one or more third party sites are selectable from said social marketing site for said display of said one or more options for selecting one or more products for recommendation or said one or more recommendation buttons.

15. The system of claim 10, wherein said social marketing server enables incentivizing said first user of said social marketing server upon buying and/or selling of said one or more recommended products by said second user.

16. A non-transitory computer-readable medium storing computer executable instructions that, when executed by a social marketing server having one or more physical processors, configure said social marketing server to perform operations comprising:
presenting a user interface for a social marketing site on a client device, said user interface comprising one or more options for selecting one or more products for recommendation;
generating one or more recommendation buttons for one or more recommended products selected by a first user from said one or more options for selecting said one or more products for recommendation;
displaying said one or more recommendation buttons linked to one or more activities and/or contents that identify said first user on one or more web pages of said social marketing site or of one or more third party sites, said one or more web pages being accessible by one or more other users; and
loading a product page corresponding to a recommendation button of said one or more recommendations buttons on being clicked by said one or more other users, said product page having one or more options for buying and/or selling said one or more recommended products.

17. The non-transitory computer-readable medium of claim 16, wherein said one or more recommendation buttons are presented as per interest of said one or more other users.

18. The non-transitory computer-readable medium of claim 16, wherein said user interface further comprises one or more options for selecting said one or more other users.

19. The non-transitory computer-readable medium of claim 16, wherein said user interface further comprises one or more options for selecting a position on said one or more web pages for said display of said one or more recommendation buttons.

20. The non-transitory computer-readable medium of claim 16, wherein said one or more third party sites include online streaming sites.
